(19) United States
(12) Patent Application Publication
(10) Pub. No.: US 2022/0205851 A1
(43) Pub. Date: Jun. 30, 2022

(54) Calibration System for Fiber Optic Temperature Probe

(71) Applicant: Photon Control Inc., Richmond (CA)

(72) Inventors: Reza DAVAR, North Vancouver (CA); Timothy BRAY, Richmond (CA); Michael FEAVER, Richmond (CA); Trevor Sonny LUM, Vancouver (CA)

(73) Assignee: Photon Control Inc., Richmond (CA)

(21) Appl. No.: 17/697,220

(22) Filed: Mar. 17, 2022

Related U.S. Application Data
(63) Continuation of application No. PCT/CA2020/051256, filed on Sep. 18, 2020.
(60) Provisional application No. 62/903,486, filed on Sep. 20, 2019.

(51) Int. Cl. G01K 11/32; G01K 15/00

(52) U.S. Cl. CPC G01K 11/32; G01K 15/005

(57) ABSTRACT

A temperature sensing system is provided, including an optical temperature sensing probe; a cable coupled to the probe for interfacing the probe with a converter via a connector; an optical fiber carried through the cable from the probe; and a calibration module positioned in the probe or connector, wherein the connector comprises at least two electrical conductors to enable the calibration module to communicate with the converter via the connector. A connector is also provided for connecting an optical temperature sensing probe to a converter via a cable coupled to the connector, the connector including a bore for carrying an optical fiber from the cable to the converter; at least two contact points; and at least two electrical connections via the at least two contact points. An extension cable is also provided for connecting an optical temperature sensing probe to a converter, the extension cable comprising a first end and a second end, and at least two electrical conductors extending between the first end and the second end to carry a signal from the probe to the converter via the extension cable.

### CROSS-REFERENCE TO RELATED APPLICATION(S)

This application is a Continuation of PCT Application No. PCT/CA2020/051256 filed Sep. 18, 2020, and claims priority to U.S. Provisional Patent Application No. 62/903,486 filed on Sep. 20, 2019, the contents of which are incorporated herein by reference in their entirety.

### TECHNICAL FIELD

The following relates generally to fiber optic temperature probes and in particular to calibration systems for such fiber optic temperature probes.

### BACKGROUND

Fiber optic temperature sensors, such as temperature probes, normally include an optical fiber which can deliver light to a sensing material (e.g., phosphor). The light illuminates the phosphor which, in turn, luminesces visibly. The temperature of the phosphor can be determined by observing the changes in certain characteristics of the emitted light.

Like temperature sensors, thermographic phosphor sensors do not directly measure temperature but instead measure a physical property that exhibits strong temperature dependence, e.g., phosphorescence time decay. When this property is measured relative to a stable and accurate temperature source, the resulting relationship, or calibration curve can then be used to convert between the measured physical property, e.g., time decay, and temperature, enabling sensor functionality.

This approach has been successfully used in the production of thermographic phosphor sensors with the use of a single calibration curve for product families (known as ‘batch calibration’), or by individually matching calibration curves with sensing elements, (known as ‘matched calibration’). The issue with the batch calibration approach is that an upper limit is imposed on the probe accuracy capabilities based on manufacturing probe capability. On the other hand, matched calibration systems can provide much higher accuracies but are limited by the fact that sensing elements and the associated electronics are not interchangeable, normally limiting the appeal of these units.

It is an object of the following to address the above-noted concerns with providing calibration data for fiber optic temperature sensors such as temperature probes.

### SUMMARY

In one aspect, there is provided a temperature sensing system comprising: an optical temperature sensing probe; a cable coupled to the probe for interfacing the probe with a converter via a connector; an optical fiber carried through the cable from the probe; and a calibration module positioned in the probe or connector, wherein the connector comprises at least two electrical conductors to enable the calibration module to communicate with the converter via the connector.

A connector for connecting an optical temperature sensing probe to a converter via a cable coupled to the connector, the connector comprising: a bore for carrying an optical fiber from the cable to the converter; at least two contact points; and at least two electrical connections via the at least two contact points.

An extension cable for connecting an optical temperature sensing probe to a converter, the extension cable comprising a first end and a second end, and at least two electrical conductors extending between the first end and the second end to carry a signal from the probe to the converter via the extension cable.

### BRIEF DESCRIPTION OF THE DRAWINGS

Embodiments will now be described with reference to the appended drawings wherein:

FIG. 1 is a schematic diagram of a prior art fiber optic temperature probe storing calibration data on the converter side.

FIG. 2A is a schematic diagram of a smart probe and universal converter storing calibration data on the probe side.

FIG. 2B is a schematic diagram of a smart probe and universal converter storing calibration data on the probe side in another configuration.

FIG. 2C is a schematic diagram of a smart probe and extension cable.

FIG. 2D is a schematic diagram of a smart probe and extension cable in another configuration.

FIG. 2E is a schematic diagram of a smart probe and extension cable in yet another configuration.

FIG. 3A is a schematic diagram of a connector for a universal converter for a smart probe illustrating insertion of a male connector component into a female connector component.

FIG. 3B is a schematic diagram of the connector shown in FIG. 3A in a connected state.

FIG. 4 is a flow chart illustrating computer executable instructions for providing calibration data from a smart probe to a universal converter.

FIG. 5 is a schematic diagram of a multi-point contact jack for connecting a smart probe to a universal converter.

FIG. 6 is a partial pictorial view of a cutaway of a cable having a fiber optic element.

FIGS. 7A, 7B, and 7C are schematic diagrams illustrating a connection between a smart probe and universal converter using the multi-point contact jack shown in FIG. 5.

FIG. 8 provides a cross-sectional view of a multi-point ST compatible connector in a disconnected state.

FIG. 9 provides a cross-sectional view of the multi-point ST compatible connector of FIG. 8 in a connected state.

FIG. 10 provides a plan view of the multi-point ST compatible connector of FIG. 9.

### DETAILED DESCRIPTION

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

To address the potential drawbacks of both the matched and batch calibration approaches, a system is described herein that enables calibration data to be stored on the probe side rather than in the converter, and a universal converter to therefore be utilized. It is recognized herein that such a “smart” probe approach requires two or more electrical connections between the smart probe and the converter, in order to pass calibration information or other settings/information between the probe sensor and the electronics in the converter. It has been found that existing optical connectors do not provide a mechanism for electrical connection in this way.

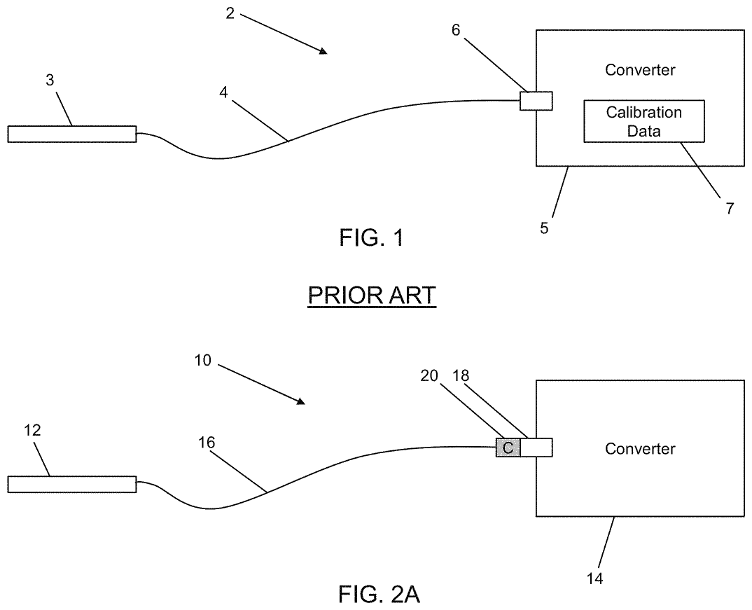

An example of a prior art temperature measurement system 2 is shown in FIG. 1, which includes a probe 3 and cable 4 connected to a converter 5 via a connector 6. This system 2 stores calibration data 7 for a model of temperature probes in an electronic module, such as an EEPROM chip located in the converter 5. A common connector 6 used in the field of phosphorescent temperature probes is the “ST” connector 6. This connector 6 joins two optical fibers and is commonly used to connect the temperature probe 3 to the temperature converter 5 that converts the temperature to an electrical signal. However, as discussed above, there is a need to obtain higher accuracy of measurements, and one way to achieve this is to customize the calibration coefficients to a unique probe. To implement this, it is more convenient to store the calibration coefficients on the probe side of the connector 6 rather than in the converter 5 itself.

To have the calibration coefficients located on the probe side requires electrical conductors to convey the calibration coefficients from the probe 3 to the converter 5, which cannot be achieved with the arrangement shown in the prior art system 2 illustrated in FIG. 1.

The new system described herein allows the electronic calibration coefficients to be transferred over a connector to enable a “universal” converter to be provided. Various embodiments of connectors are described, including one that is fully compatible with the ST connector. This allows both old and newer temperature probes to be interchanged and can make the adoption of higher accuracy probes easier.

As described above, the approach of matching phosphor sensing elements with an individual converter unit can be used to achieve a higher-than-typical level of measurement accuracy. However, the need to match units is unappealing to both manufacturer and customer due to the constraints it places on product usability. By enabling the calibration coefficients to be placed on the probe side, can avoid these unappealing constraints.

That is, the new system described herein can effectively combine the strengths of the batch and matched calibrated approaches by storing probe-specific calibration data on the probe or cable itself (collectively a ‘smart probe’) in an electronic module, for example an EEPROM chip or similar component. The calibration data from any individual smart probe can then be read by an electronics unit or ‘universal converter’ which detects the decay time and uses the smart probe's individual calibration curve to convert this to a temperature with a higher accuracy than that achieved using the batch calibration method. Importantly, when using this approach, system interchangeability is maintained as opposed to the matched calibration approach.

In an implementation, a connector that provides electrical connections can include a tip-sleeve, tip-ring-sleeve, or tip-ring-ring-sleeve type connectors, similar to those often used for audio jacks, but modified to include a bore down the centre that can accommodate an optical fiber.

In another implementation, the connector can connect an optical fiber and electrical conductors in a single connector that is backward and forward compatible with an ST connector that typically only connects an optical fiber.

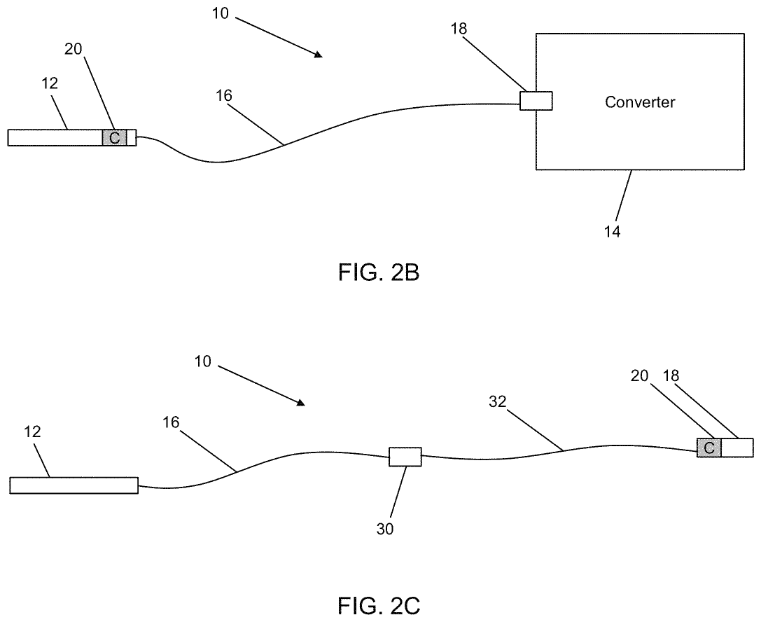

Referring now to FIG. 2A, a temperature sensing system 10 according to the principles discussed herein is shown. The system 10 includes a fiber optic temperature probe 12 that connects to a converter 14 via a cable 16 and connector 18. The cable 16 includes an optical fiber to carry an optical signal. As discussed in greater detail below, the connector 18 includes a first connector component on the “probe side”, and a second connector component on the “converter side”. It can be appreciated that while certain examples herein may illustrate the first connector component as a male connector component and the second connector component as a female connector component, this configuration can be reversed. As can be seen in FIG. 2A, the probe side of the connector 18 stores or otherwise includes or houses calibration data 20, also denoted using the character “C”. In the configuration shown in FIG. 2A the calibration data 20 is stored in the probe side of the connector 18 to reduce the length of the electrical connections between the electronic component(s) used to store the calibration data 20 and the electronics in the converter 14 which obtain and utilize the calibration data 20.

FIG. 2B illustrates another example configuration for the system 10 in which the calibration data 20 is stored in the probe 12. It can be appreciated that the probe side of the connector 18 would still require the electrical connections between the module storing the calibration data 20 and the electronics in the converter 14. Additionally, the cable 16 in this configuration would also require electrical wiring to complete these electrical connections.

FIG. 2C illustrates yet another example configuration for the system 10 in which an extension cable 32 is connected to the probe's cable 16 via an intermediate connector 30. In this configuration, the extension cable 32 includes the probe side of the connector 18 that stores the calibration data 20. It can be appreciated that the details of the converter 14 have been omitted from FIG. 2C for clarity and ease of illustration.

FIG. 2D illustrates another configuration for an extension cable 32 in which the probe 12, cable 16 and connector 18 are similar to that shown in FIG. 2A, but the converter side of the connector 18 is instead one end of the extension cable 32 which includes a second connector 30 that would connect directly into the converter 14. As with FIG. 2C, details of the converter are omitted from FIG. 2D for clarity and ease of illustration. It can be appreciated that in this configuration a normally used probe 12, cable 16, and probe side portion of the connector 18 housing the calibration data 20 can be extended by attaching the extension cable 32 where the connector 18 would normally interface with the converter 14. The extension cable 32 would, in this configuration, require electrical wiring therealong to enable the probe 12 to communicate the calibration data 20 to the converter 14. FIG. 2E provides yet another configuration that is similar to FIG. 2D but for the probe configuration shown in FIG. 2B in which the calibration data 20 is stored in the probe 12. It can be appreciated that the various configurations shown in FIGS. 2A-2E are illustrative and other configurations are possible. For example, multiple extension cables 32 may be utilized. Moreover, while the calibration data 20 is shown as being stored in either the probe 12 or the connector 18, other components could be used and integrated into the cable 16 or extension cable 32.

It can be appreciated that to address potential effects on the accuracy of the system 10 that can vary based on the length of the extension cable 32, the extension cable 32 can also include memory (not shown). The memory can be used to store information related to the optical properties of the extension cable 32. In this way, the system 10 can read the information from the connected extension cable(s) 32 and factor that into the temperature calculations. The memory can be separately addressed and read from what is known as a one-wire connection, which typically requires 2 or 3 conductors.

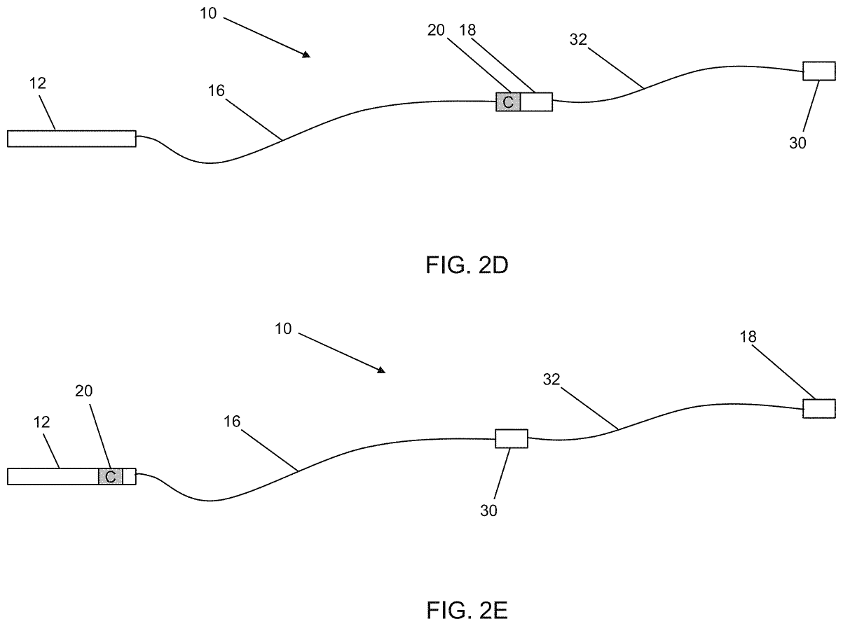

Turning now to FIG. 3A, further detail for the connector 18 and its interface with the converter 14 is shown. The connector 18 in this example includes a male component 40 that is insertable or otherwise connectable in or to a female component 42, wherein the female component 42 is integrated into the converter 14 and provides a socket for the probe 12 and cable 16 (not shown in FIG. 3A). The male component 40 is connected to a distal end of the cable 16, the proximal end of the cable 16 being connected to the probe 12. The male or probe side connector 40 includes a bore, cavity or otherwise accommodates an optical fiber 44. The optical fiber 44 extends from the probe 12 and through the cable 16 to terminate in the male component 40. By connecting the male component 40 to the female component 42 the optical fiber 44 can optically communicate with optical components 58 in the converter 14. In the example illustration in FIG. 3A, the lens on the left is used to collimate light from the optical fiber 44, the diagonal mirror is a dichroic filter that transmits light that is greater in wavelength than a specified cutoff wavelength and reflects light that is less than a certain cutoff wavelength. The lens on the right of the diagram focuses light onto a photodetector and the lens at the bottom of the diagram collimates light from an LED.

The male connector 40 also includes a calibration module 46 for storing the calibration data 20. In this example, the calibration module 46 includes a processor 48 and a memory 50 coupled to the processor 48. The memory 50 stores the calibration data 20 and enables the processor 48 to obtain the calibration data 20 from memory 50 and provide same to a converter module 56 in the converter 14. The converter module 56 herein represents the hardware, software, firmware, etc. that is configured to use the calibration data 20 as herein described, e.g., to use a calibration curve to convert between a measured property (time decay acquired by the probe 12) and temperature, enabling functionality of the system 10.

The male connector 40 also includes at least a first electrical connection 52 (e.g. a signal ground) and a second electrical connection 54 (e.g., signal) that connect the calibration module 46 to the converter module 56 via the connector 18. Depending on the type of connector 18, a chassis ground connection may also be provided. That is, when the male connector 40 connects to the female connector 42 as shown in FIG. 3B, the first and second electrical connections 52, 54 are made (e.g., ground and signal) such that the converter module 56 can obtain the calibration data 20 from the calibration module 46 on the probe side of the connector 18 using these electrical connections. The electrical connections shown in FIGS. 3A and 3B are purely illustrative and schematic and would be located at different contact points depending on the type of connector 18 being used (as explained and illustrated below). In this way, the converter 14 can be “universal” to multiple probe models each having their own calibration data 20 stored on the probe side of the connection. It can be appreciated that the sizes, proportions and scale of the components shown in FIGS. 3A and 3B are made for the purpose of illustrating the above principles and should not be considered limiting. For example, the calibration module 46 may be provided by a relatively smaller electronic component such as an EEPROM on a printed circuit board (PCB), e.g., a flexible PCB.

It can be appreciated that the system 10 enables the use of a sensing element that includes a phosphor material whose emission characteristics vary strongly as a function of temperature and exhibit highly stable properties after exposure to temperature limit points. Moreover, this enables a method of defining a continuous calibration curve for individual units. In this way, the calibration curve can be generated using a number of temperature calibration points required to accurately describe the calibration curve over the full probe operating temperature. Additionally, the interchangeability of the “universal” converter 14 and “smart” probe 12 can be achieved by using calibration constants stored on a calibration module 46 (e.g., using an EEPROM or similar device) for conversion of time decay values to a usable, and highly accurate, temperature measurement.

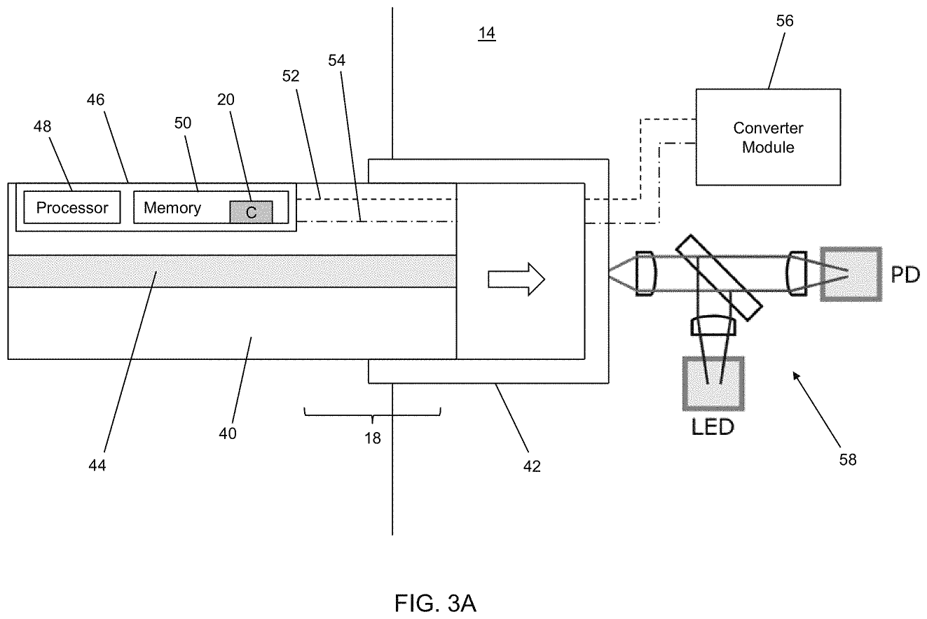

Turning now to FIG. 4, a flow chart is provided illustrating a process for utilizing probe side calibration data 20. At step 100, the converter 14 (e.g., via the converter module 56) detects that the probe 12 has been connected. At step 102 the converter 14 communicates with the calibration module 46 of the connected probe 12 and at step 104 obtains the calibration data 20 for that probe 12. This can be done, for example, by the converter module 56 communicating with the calibration module 46 via the electrical connections 52, 54. For example, typical communication protocols include 1-wire communication. A digital I/O pin or UART on a microcontroller can be used to drive communication on the bus, which can include slave devices like temperature sensor probes 12 and extension cables 32. At step 106 the converter module 56 utilizes the calibration data 20 to convert the measured property determined via the optical fiber 44 (through the connection 18) to a temperature measurement, using the components 58. At step 108 the converter 14 may detect a disconnection of the probe 12 and repeat the process shown when it next detects the connection of a probe 12, which may be the same probe 12 or a different probe 12 having different calibration data 20.

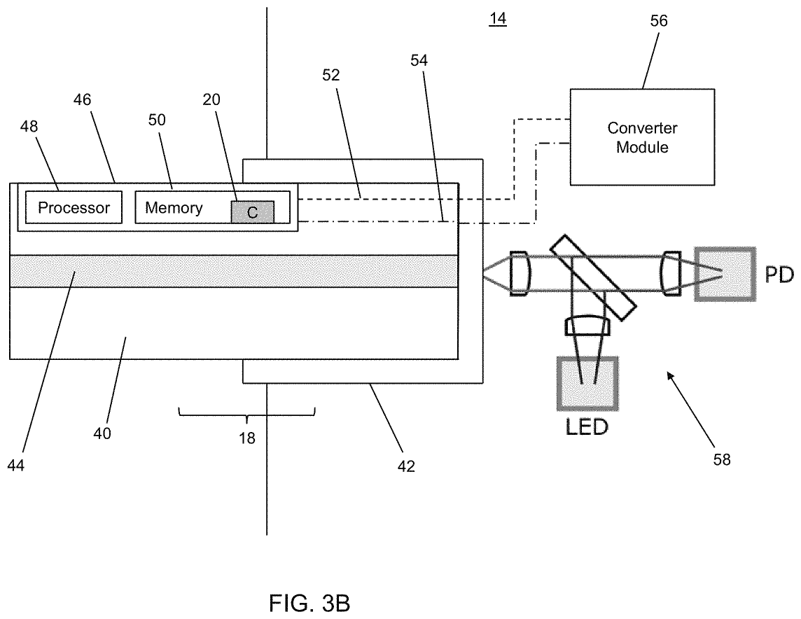

The connector 18 can be implemented in various ways in order to combine optical connectivity while also permitting electrical connectivity to allow the calibration data 20 to be stored on the probe side of the connection. FIG. 5 illustrates one such implementation that uses an audio-jack style multi-point jack as the male connector 140. In this example, a bore or cavity is made through the center of the male connector 140 to permit the optical fiber 44 to be carried through the male connector 140. With this structure, a calibration housing 150 can be created to house the calibration module 46 storing the calibration data 20 (details of the module 46 omitted for ease of illustration). The connector 140 includes a strain relief clamp, a sleeve connection point 152 providing an electrical connection to the sleeve 160, a ring connection point 156 providing an electrical connection to the ring 162, and a tip connection point 158 providing an electrical connection to the tip 164. This provides the at least two connections to permit the electrical connections 52, 54 to be made with the calibration module 46. In the example shown in FIG. 5, the first electrical connection 52 is made via the tip 164 while the second electrical connection 54 is made via the ring 162. It can be appreciated that the sleeve connection point 154 can be used for another connection such as a ground (not shown). Preferably, there are three wires and three contacts on each side, with at least two wires. A cable shield connected to the chassis ground connection helps to shield the signal and ground wires that are internal to the shield. A male connector 140 as shown in FIG. 5 can prove a tip-ring-sleeve, or tip-sleeve-tip or tip-ring-ring-sleeve type of connection and the example shown in FIG. 5 is illustrative.

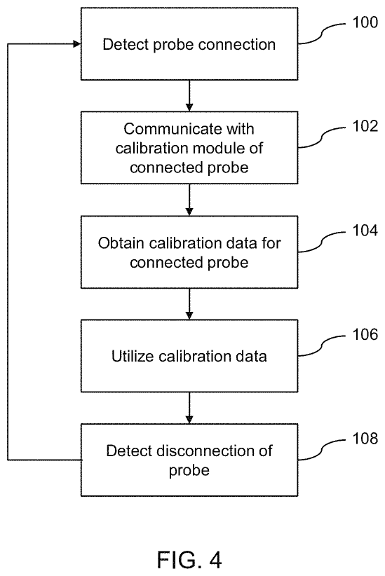

FIG. 6 illustrates a triaxial type of cable 16, 32 with the optical fiber 44 running therethrough. This permits the cable 16 to transmit at least two electrical signals that run alongside or around the optical fiber 44 for implementations where the electrical signals 52, 54 are transmitted along the cable 16 or extension cable 32 (or both). A typical triaxial cable could be used with the central conductor removed and replaced with the optical fiber 44.

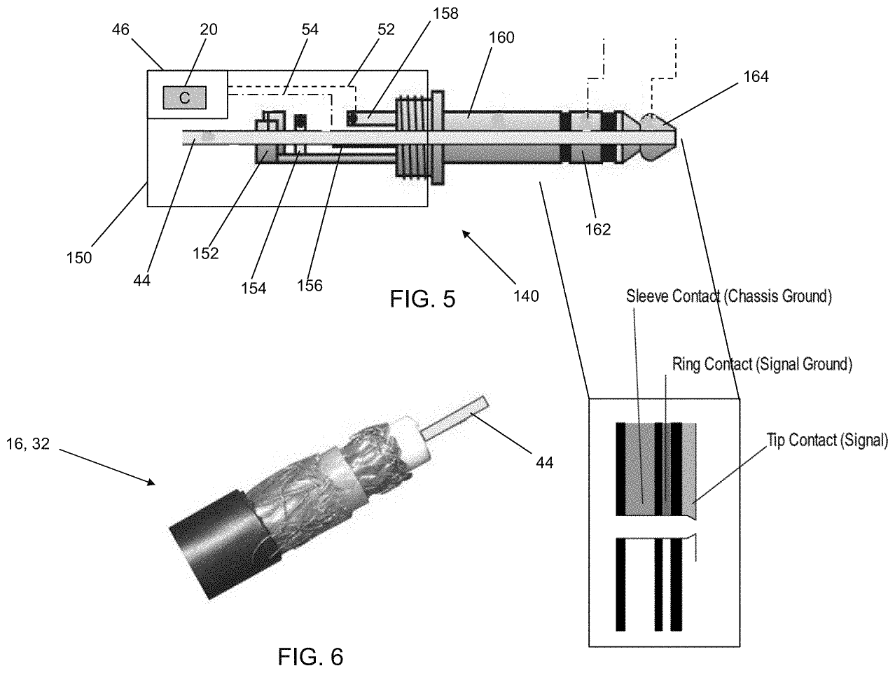

FIGS. 7A-7C illustrate a connection being made using a male connector 140 as shown in FIG. 5 with an inset view provided to show the conducting versus insulating components. As seen in FIG. 7B, the converter 14 can be adapted to include a complementary socket-type female connector component 142, similar to an audio jack socket to include conductive components to complete the electrical connections 52, 54. The connection is illustrated in FIG. 7C to illustrate the electrical and optical connections being made using the connector components 140, 142

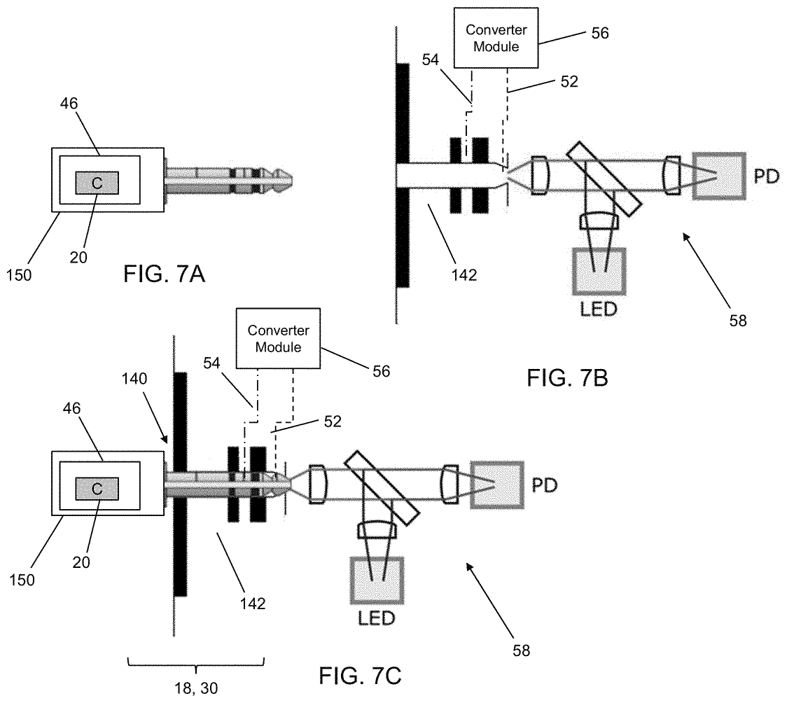

Another implementation of the connector 18 is shown in FIGS. 8-10 in which an ST-type connector is enhanced to both store the calibration data 20 and permit the electrical connections 52, 54. Turning first to FIG. 8, a first male connector component 240 includes an optical fiber 44 fed through a shaft 250. The shaft 250 feeds through a housing 253. A flexible PCB 252 is supported on the housing 253 and contains the calibration module 46, e.g., an EEPROM. A spring 254 provides an electrical connection with the flexible PCB 252 and bears against a nut 256 that can be turned about the housing 253. As can be seen in FIG. 8, the shaft 250 and optical fiber 44 protrude from the nut 256 and are insertable to a second male connector component 241 that interfaces with a female connector component 242 (see FIG. 11 for example).

The second male connector component 241 includes an adapter that receives the shaft 250 and interacts with the nut 256 to make the connection. An adapter sleeve 260 is positioned within the adapter 260. As illustrated in FIG. 8, the arrangement of the components in this manner provides the first electrical connection 52 from the module 46 to the flexible PCB 252 to the spring 254 to the nut 256 and then to the adapter 258. The second electrical connection 54 is provided from the module 46 to the flexible PCB 252 to the shaft 250 to the adapter sleeve 260, which contacts the shaft 250 when the first male connector component 240 is inserted into the second male connector component 241.

It can be appreciated that several modifications may be required to a standard ST connector to arrive at what is shown in FIG. 8. For instance, a normal ST connector allows for at least intermittent conduction between the male ferrule and the bayonet nut. On both the probe side and the converter side, the ST connector shown in FIG. 8 is carefully split into two conducting paths and an intermediate insulating path. On the converter side, one conducting path follows the exterior, the exterior conducting path going from the EEPROM over the flex PCB, through the thin spring, and into the nut. The nut on the probe then contacts to the outside of the adapter on the converter. On the interior, the other conducting path flows from the EEPROM through a different wire on the flexible PCB, and into the shaft/ferrule. The shaft/ferrule on the probe contacts the interior adapter sleeve on the converter. The insulator 261 separates the two paths.

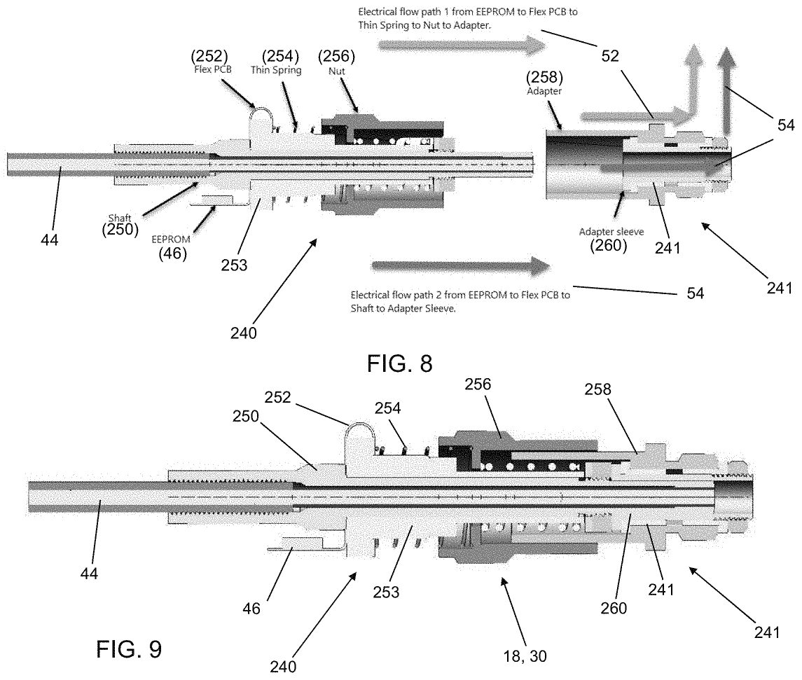

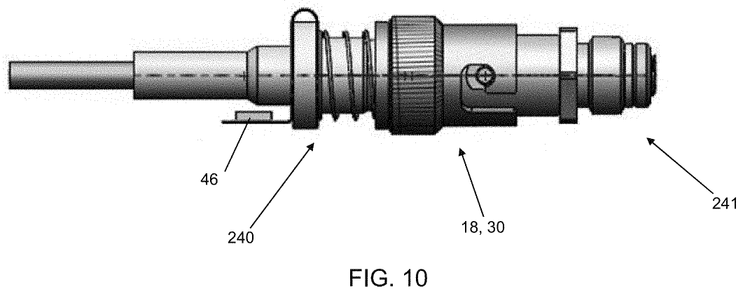

FIG. 9 illustrates the components 240, 242 when a connection has been made, and FIG. 10 shows an external view.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the calibration module 46, probe 12, connector 18, 30 or converter 14, any component of or related thereto, or accessible or connectable thereto. Any application or module herein described may be implemented using computer readable/executable instructions that may be stored or otherwise held by such computer readable media.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A temperature sensing system comprising:
an optical temperature sensing probe;
a cable coupled to the probe for interfacing the probe with a converter via a connector;
an optical fiber carried through the cable from the probe; and
a calibration module positioned in the probe or connector, wherein the connector comprises at least two electrical conductors to enable the calibration module to communicate with the converter via the connector.

2. The system of claim 1, wherein the calibration module is positioned in a male portion of the connector.

3. The system of claim 1, wherein the calibration module is position in the probe, wherein the cable comprises at least two electrical conductors.

4. The system of claim 1, wherein the calibration module comprises a processor, memory, and calibration data stored in the memory, the calibration data being specific to the probe.

5. The system of claim 1, wherein the calibration module is positioned in a connector of an extension cable connected between the probe and the converter.

6. The system of claim 5, wherein the extension cable comprises memory to store information related to the optical properties of the extension cable.

7. The system of claim 1, wherein the connector comprises a bore through which an optical fiber passes from the probe to the converter.

8. The system of claim 1, wherein the connector comprises:
a bore for carrying an optical fiber from the cable to the converter;
at least two contact points; and
at least two electrical connections via the at least two contact points.

9. The system of claim 8, wherein the calibration module is connected to the contact points.

10. The system of claim 8, wherein the connector is a stereo jack type connector.

11. The system of claim 8, wherein the connector is an ST type connector.

12. A connector for connecting an optical temperature sensing probe to a converter via a cable coupled to the connector, the connector comprising:
a bore for carrying an optical fiber from the cable to the converter;
at least two contact points; and
at least two electrical connections via the at least two contact points.

13. The connector of claim 12, further comprising a calibration module connected to the contact points.

14. The connector of claim 12, wherein the connector is a stereo jack type connector.

15. The connector of claim 12, wherein the connector is an ST type connector.

16. The connector of claim 12, further comprising an adapter connected to a distal end of the cable to adapt the cable to connect to the converter.

17. An extension cable for connecting an optical temperature sensing probe to a converter, the extension cable comprising a first end and a second end, and at least two electrical conductors extending between the first end and the second end to carry a signal from the probe to the converter via the extension cable.

18. A method of connecting an optical temperature sensing probe to a converter via a cable coupled to the connector, the method comprising:
positioning a calibration module in the probe or connector;
establishing at least two communication paths between the calibration module and the converter; and
enabling calibration data to be passed between the calibration module and the convertor via one or more of the communication paths.

19. The method of claim 18, wherein the connector comprises at least two electrical conductors to provide the at least two communication paths.

20. The method of claim 18, further comprising connecting an adapter between the connector and the converter.
